(19) United States
(12) Patent Application Publication
(10) Pub. No.: US 2026/0049688 A1
(43) Pub. Date: Feb. 19, 2026

(54) SYSTEM AND APPARATUS FOR MOUNTING A FAN

(71) Applicant: Cornelius D. Davidson, Tuscaloosa, AL (US)

(72) Inventor: Cornelius D. Davidson, Tuscaloosa, AL (US)

(21) Appl. No.: 19/371,455

(22) Filed: Oct. 28, 2025

Related U.S. Application Data
(63) Continuation-in-part of application No. 18/939,575, filed on Nov. 7, 2024.
(60) Provisional application No. 63/547,614, filed on Nov. 7, 2023.

(51) Int. Cl. F16M 13/02; F04D 29/64

(52) U.S. Cl. CPC F16M 13/02; F04D 29/646; F16M 13/027

(57) ABSTRACT

An apparatus for mounting a fan is disclosed. The apparatus includes an elongated bar such as M bar, for example. The elongated bar connects between walls and positions in parallel to a ceiling of a structure. Alternatively, the elongated bar is mounted vertically on a base and positions in parallel to the walls. The elongated bar receives one or more fans. In one example, the bar is comprised of two lengths, and includes a central bracket for joining and support. with an electrical junction box. The position of the fans is adjusted along the length of the elongated bar depending on the need. In one example, the apparatus includes an electrical outlet positioned at the wall and perpendicularly to the ceiling. The fans operate using electrical energy drawn via the electrical outlet through a cable which leads to the electrical junction box.

### CROSS-REFERENCE TO RELATED APPLICATIONS

The present application is a continuation-in-part of U.S. Non-Provisional application Ser. No. 18/939,575, filed Nov. 7, 2024; which claims the benefit of U.S. Provisional Application No. 63/547,614, filed Nov. 7, 2023, all of which are incorporated herein in their entirety and referenced thereto.

### BACKGROUND OF THE INVENTION

### Field of the Invention

The present invention relates to household fixtures, and in particular, relates to an apparatus for mounting a fan with the help of an elongated bar extended between walls or extended from a ceiling to a floor.

### Description of the Prior Art

It is known that fans are used to circulate air within an enclosed room. Typically, the fans are positioned at a height from the ground/floor to deliver air to an elevation which is sensed by persons occupying the room. With time, the fans have been mounted to ceiling, wall, or other structures like poles using support devices.

Several ways of mounting fans have been disclosed in the past. One such example is disclosed in a United States Granted U.S. Pat. No. 5,603,562, entitled “Combination fan/lamp” (“the '562 Patent”). The '562 Patent discloses a combination fan/lamp having a base, an upstanding base column on the base, a ring-shaped frame fixedly supported atop the base column for mounting a fan assembly having a motor that is spaced from the frame; a fixture column rigidly extending upwardly from the frame and having an illuminating fixture atop the fixture module column. In one configuration, the fan lamp further includes a lamp head that is supported in a desired position and orientation relative to the frame on a curvable gooseneck that projects from the frame, the gooseneck being sufficiently long for holding a full loop thereof while supporting the lamp head. In preferred configurations, modular mechanical and electrical connections are provided between the base and the frame and/or between the frame and the fixture. The fan assembly can be adjustably oriented relative to a main air path that is perpendicular to the base column. Also, the fan lamp can be provided with an oscillating fan.

Another example is disclosed in a Chinese Publication No. 106168225, entitled “Movable industrial ceiling fan” (“the '225 Publication”). The '225 Publication discloses a movable industrial ceiling fan. The movable industrial ceiling fan comprises a sliding plate, sliding teeth, a sliding groove, a case body, a signal receiver, a ceiling fan body, a fixed box, screw spikes, a remote controller, a power line, a reel, a central control unit, a driver and a sliding block; the sliding groove is formed in the sliding plate, the sliding teeth are arranged at the top end of the sliding groove, the fixed box is arranged at one end of the sliding plate, the case body is arranged at the top end of the sliding plate, the signal receiver is arranged at one end of the case body, the signal receiver is in signal connection with the remote controller, the ceiling fan body is arranged at the bottom end of the case body, the central control unit is arranged in the case body, the central control unit is electrically connected with the signal receiver, the driver is arranged at the top end of the central control unit, the sliding block is arranged at one end of the driver, the sliding block is located at the top end of the sliding groove, the reel is arranged in the case body, the power line is arranged in the reel, and the power line is electrically connected with the central control unit. The industrial ceiling fan is simple in structure, convenient to operate and suitable for popularization.

Another example is disclosed in a United States Granted U.S. Pat. No. 5,845,886, entitled “Adjustable ceiling fan support assembly” (“the '886 Patent”). The '886 Patent discloses an adjustable ceiling fan support assembly for use in recreational vehicles, motor homes, camper shells and the like to removably suspend a ceiling fan from opposing vertical supports. A spring-biased adjustable fan support is interposed between two vertical supports, such as the interior walls of a recreational vehicle or retractable awning frames, and the fan is suspended from the support. The support includes a pair of generally parallel, elongated support arms having a fixed component and a reciprocable component. The fixed component depends from diametrically opposed edges of a plate. The reciprocable component has an engaging end portion, slidably engaged with the fixed component, and a wall engaging end. Each support arm further has a coil spring operably disposed between the fixed component and the reciprocable component so as to cause a biasing force of the reciprocable component away from the fixed component, whereby each reciprocable member may be compressed and interposed between two vertical surfaces and released to engage an associated vertical surface to suspend the fan. The fan may be specially adapted for use with a 12V DC current supplied by most RVs, and have easily removable fan blades.

Although the above discussed disclosures are useful, they still have problems and present incomplete solutions. For example, the fan is typically permanently mounted to the ceiling. Further, the fan support assembly takes up a significant amount of space in the room.

Therefore, there is a need in the art to provide an improved apparatus for mounting a fan with the help of an elongated bar extended between walls or extended from a ceiling to a floor.

### SUMMARY OF THE INVENTION

It is an object of the present invention to provide an apparatus for mounting a fan that avoids the drawback of known mounting mechanisms.

It is another object of the present invention to provide an apparatus for mounting a fan with the help of an elongated bar extended between walls or extended from a ceiling to a floor.

In order to achieve one or more objects, the present invention provides an apparatus for mounting a fan. The apparatus includes an elongated bar such as an M bar, for example. In one embodiment, the elongated bar connects between walls and positions in parallel to a ceiling of a structure. Here, the elongated bar connects to the walls using known mechanisms, including but not limited to, fasteners, welding, adhesive, clamps, etc. In another embodiment, the elongated bar connects between the ceiling and a floor and positions in parallel to the walls and perpendicularly to the ceiling. The elongated bar receives one or more fans. In one example, the apparatus includes a control board positioned at the wall. The position of the fans is adjusted along the length of the elongated bar depending on the need. In one example, the apparatus includes a control board positioned at the wall. The control board includes a cable connecting at one end of the elongated bar. The fans operate using an electrical energy drawn via the control board through the cable. The control board includes a cable connecting at one end of the elongated bar. The fans operate using an electrical energy drawn via the control board through the cable.

The elongated bar receives one or more fans. In one example, the apparatus includes a control board positioned at the wall. The control board includes a cable connecting at one end of the elongated bar. The fans operate using an electrical energy drawn via the control board.

In one advantageous feature of the present invention, the elongated bar connects to walls of opposite sides and helps to connect one or more fans. Alternatively, the elongated bar is connected to the ceiling and floor. The elongated bar helps to avoid connecting the fan directly to the ceiling or wall. The position of the fans can be adjusted along the length of the elongated bar depending on the need.

In another advantageous feature of the present invention, the elongated bar receives the cable at one end thereby preventing drawing of the cable through the walls and/or ceiling by chipping off a portion of the walls and/or ceiling or using additional cable concealing mechanisms.

In another advantageous feature of the present invention, the elongated bar comes in an M bar configuration. In other words, the elongated bar includes an M-shaped cross-section having two raised portions forming a channel therebetween. The M bar configuration includes two raised portions forming a channel therebetween. The M bar configuration enables the cable to be drawn in the channel facing the ceiling i.e., in between the elongated bar and the ceiling. This ensures cable is not seen from underneath the fan.

These and other objects of the present subject matter will be apparent from review of the following specification and the accompanying drawings.

### BRIEF DESCRIPTION OF THE DRAWINGS

FIG. 1 illustrates an environment in which an apparatus for mounting a fan implements, in accordance with one embodiment of the present invention.

FIG. 2 illustrates the apparatus having an elongated bar, in accordance with one embodiment of the present invention.

FIG. 3 illustrates an environment in which an apparatus for mounting a fan implements, in accordance with another embodiment of the present invention.

FIG. 4 illustrates an environment in which an apparatus for mounting a fan implements, in accordance with another embodiment of the present invention.

FIG. 5 illustrates an environment in which an apparatus for mounting a fan implements, in accordance with yet another embodiment of the present invention.

FIG. 6 illustrates an environment in which an apparatus for mounting a fan implements, in accordance with yet another embodiment of the present invention.

### DETAILED DESCRIPTION OF THE PREFERRED EMBODIMENT

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed apparatus. However, it will be apparent to those skilled in the art that the presently disclosed invention may be practiced without these specific details. In some instances, well-known structures and devices are shown in functional or conceptual diagram form in order to avoid obscuring the concepts of the presently disclosed apparatus.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

It will be understood that, although the terms first, second, third, etc. may be used herein to describe various elements, components, regions, and/or sections, these elements, components, regions, and/or sections should not be limited by these terms. These terms are only used to distinguish one element, component, region, and/or section from another element, component, region, and/or section.

It will be understood that the elements, components, regions, and sections depicted in the figures are not necessarily drawn to scale.

Although the present invention provides a description of an apparatus for mounting a fan, it is to be further understood that numerous changes may arise in the details of the embodiments of the apparatus. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present invention discloses an apparatus for mounting a fan. The apparatus includes an elongated bar such as M bar, for example. In one embodiment, the elongated bar connects between walls and positions in parallel to a ceiling of a structure. In another embodiment, the elongated bar connects between the ceiling and a floor and positions in parallel to the walls and perpendicularly to the ceiling. The elongated bar receives one or more fans. The position of the fans is adjusted along the length of the elongated bar depending on the need. In one example, the apparatus includes a control board positioned at the wall. The control board includes a cable connecting at one end of the elongated bar. The fans operate using an electrical energy drawn via the control board through the cable.

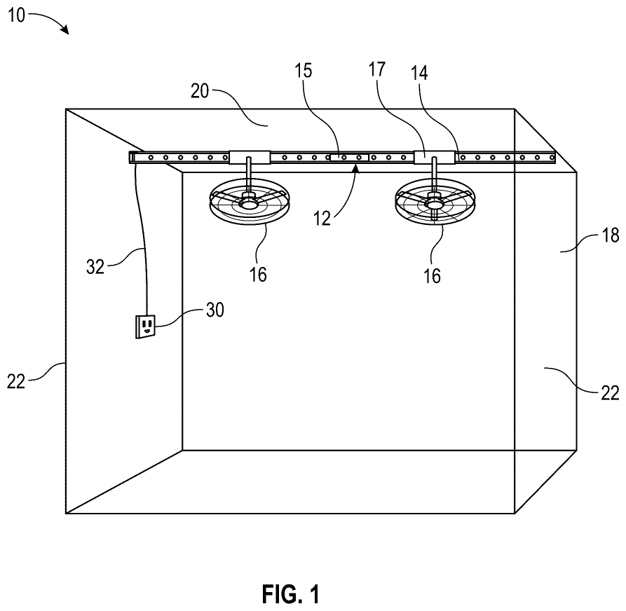

Various features and embodiments of an apparatus for mounting a fan are explained in conjunction with the description of FIGURES (FIGS. 1-6.

FIG. 1 shows an environment 10 in which an apparatus 12 implements, in accordance with one embodiment of the present invention. Apparatus 12 includes an elongated bar 14 made of metal, wood or any other suitable material. In one example, elongated bar 14 includes an M bar. In the present invention, elongated bar 14 helps to hang one or more fans 16 at a structure 18. An example of fan 16 includes, but not limited to, a ceiling fan, a table fan, an exhaust fan, a wire cage fan, a wall mounted fan, etc. Structure 18 indicates a building. As can be seen, elongated bar 14 extends to connect to walls 22 at opposite sides. In one example, elongated bar 14 connects to walls 22 using known mechanisms, including but not limited to, fasteners, welding, clamps, adhesive, etc.

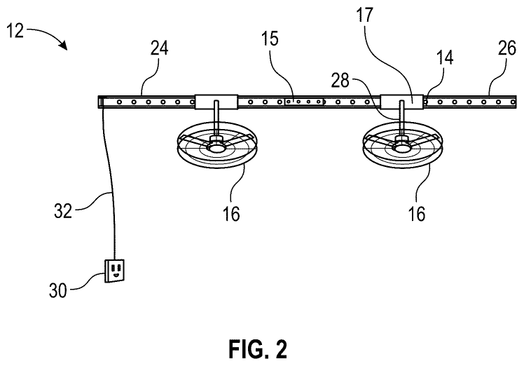

FIG. 2 shows a schematic diagram of apparatus 12, in accordance with one embodiment of the present invention. As can be seen, apparatus 12 includes elongated bar 14. Elongated bar 14 comes in a cylindrical, rectangular shape, or any other shape depending on the need. Elongated bar 14 has a suitable length to connect from one wall 22 to another wall 22 on the opposite side, as shown in FIG. 1. In one example, elongated bar 14 includes a telescopic pole that is portable and easy to adjust its length. Elongated bar 14 includes a first end 24 and a second end 26. First end 24 connects to one end/side of wall 22 and second end 26 connects to opposite end/side of wall 22. In one example, elongated bar 14 comes in two or more parts connected by a bracket 15 at the center. Elongated bar 14 includes connecting brackets 17. Each connecting bracket 17 connects to a connecting rod 28. Connecting rod 28 extends from connecting bracket 17 and receives fan 16. Referring back to FIG. 1, elongated bar 14 positions parallel and at a distance from ceiling 20. Further, elongated bar 14 positions perpendicularly to walls 22. Further, connecting rod 28 positions perpendicularly elongated bar 14 or bracket 15, as can be seen from FIG. 2. FIG. 1 and FIG. 2 illustrate an embodiment in which two fans 16 are suspended from bracket 15 via connecting rods 28. A person skilled in the art understands that more than two fans 16 can be provided that suspend from bracket 15 depending on the need, say depending on the size of structure 18 or depending on number of fans 16 required.

In one example, fans 16 draw electrical energy from a power supply through a switchboard or a control board or an electrical (wall) outlet 30. Control board 30 positions on wall 22 as shown in FIG. 1. In one example, control board 30 includes a cable 32 extending from control board 30 and connecting at one end of elongated bar 14, say at first end 24. Cable 32 draws through elongated bar 14 and supplies the electrical energy from control board 30 to fans 16 to operate them. As specified above, elongated bar 14 comes in an M bar configuration (M-shaped cross-section). It should be understood that the M bar configuration includes two raised portions forming a channel therebetween. The M bar configuration enables cable 32 to be drawn in the channel facing ceiling 20 i.e., in between elongated bar 14 and ceiling 20. This ensures cable 32 is not seen from underneath fan 16.

Alternatively, fans 16 can be operated remotely by activating a transceiver (not shown) provided in fans 16 avoiding the need for a physical cable 32 as shown in FIG. 1 and FIG. 2. Such modifications fall within the scope of the present invention.

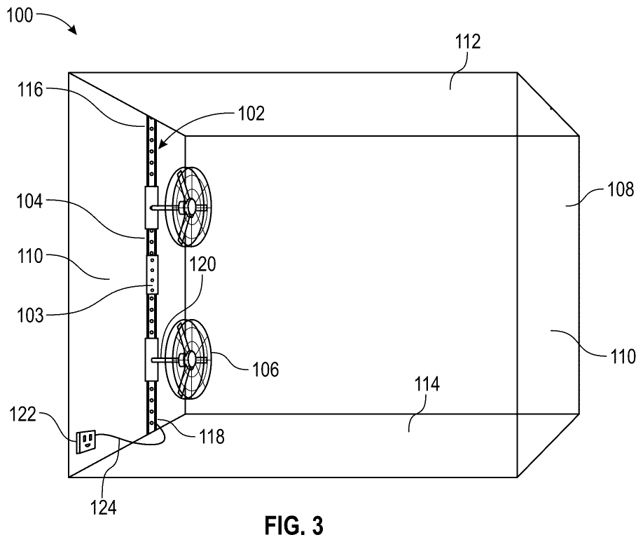

FIG. 3 shows an environment 100, in which an apparatus 102 implements, in accordance with one embodiment of the present invention. Apparatus 102 includes an elongated bar 104 made of metal, wood or any other suitable material. Elongated bar 104 has all the features of elongated bar 14 explained above. In the present invention, elongated bar 104 helps to hang one or more fans 106 at a structure 108. Structure 108 indicates a building. As can be seen, elongated bar 104 extends from ceiling 112 to a floor 114 and positions parallel to walls 110. In some implementations, elongated bar 104 comes in two or more parts connected by a bracket 103 at the center. Although it is shown that elongated bar 104 having multiple parts are connected by bracket 103, it is possible to provide a single elongated bar 104 without the need for bracket 103 and such implementation falls within the scope of the present invention. In the present embodiment, elongated bar 104 comes in an M bar configuration. It should be understood that the M bar configuration includes two raised portions forming a channel therebetween. The M bar configuration enables cable 124 to be drawn in the channel facing wall 110 i.e., in between elongated bar 104 and wall 110. This ensures cable 124 is not seen from the interior of structure 108.

In the present invention, elongated bar 104 includes a first end 116 and a second end 118. First end 116 connects to ceiling 112 and second end connects to floor 114, respectively. In one example, elongated bar 104 has a length slightly less than the distance from ceiling 112 to floor 114. Further, elongated bar 104 includes connecting rods 120. Connecting rods 120 extend perpendicularly from elongated bar 104 and connect fans 106 via connecting brackets 107.

In one embodiment, fans 106 draw electrical energy from a power supply through a switchboard or a control board 120. Control board 120 positions on wall 110 as shown in FIG. 3. In one example, control board 120 includes a cable 122 extending from control board 120 and connecting at one end of elongated bar 104, say at second end 118. Cable 122 draws through elongated bar 104 and supplies electrical energy from control board 120 to fans 106 to operate them. Alternatively, fans 106 can be operated remotely by activating a transceiver (not shown) provided in fans 16 avoiding the need for a physical cable 122 and such modifications fall within the scope of the present invention.

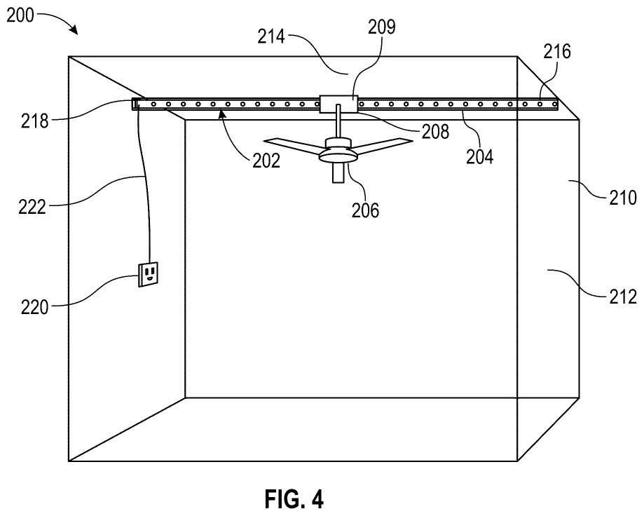

FIG. 4 shows an environment 200 in which an apparatus 202 implements, in accordance with one embodiment of the present invention. Apparatus 202 includes an elongated bar 204 made of metal, wood or any other suitable material. Elongated bar 204 has all the features of elongated bar 14 explained above. Here, elongated bar 204 helps to hang one or more fans 206 at a structure 210. Structure 210 indicates a building. In the example illustrated in FIG. 4, fan 206 includes a ceiling fan. However, other fans such as a wire cage fan may also be used depending on the need. As can be seen, elongated bar 204 extends to connect to walls 212 on opposite sides. In one example, elongated bar 204 connects to walls 212 using known mechanisms, including but not limited to, fasteners, welding, adhesive, etc.

In one implementation, elongated bar 204 comes as a single elongated bar. In another implementation, elongated bar 204 comes as two or more parts connected by a bracket 209. Bracket 209 slidably connects to elongated bar 204 and receives a fan 206 via a connecting rod 208. Elongated bar 20 includes a first end 216 and a second end 218. First end 216 connects to one end/side of wall 212 and second end 218 connects to opposite end/side of wall 212. Bracket 209 may slidably connect along the length of elongated bar 204 depending on the size of parts forming the entire length of elongated bar 204. In one example, bracket 209 positions at the center considering that elongated bar 204 is made of two equal length parts. Elongated bar 204 positions parallel to ceiling 214 and perpendicularly to walls 212. As can be seen from FIG. 4, connecting rod 208 positions perpendicularly elongated bar 204. A person skilled in the art understands that FIG. 4 illustrates a single fan 206 supported with the help of elongated bar 204 connecting walls 212.

In one example, fan 206 draws electrical energy from a power supply through a switchboard or a control board or an electrical outlet 220. Control board 220 positions on wall 212. Further, control board 220 includes a cable 222 extending from control board 220 and connecting at one end of elongated bar 204, say at second end 218. Cable 222 draws through elongated bar 204 and supplies electrical energy from control board 220 to fan 206 to operate it. As specified above, elongated bar 204 comes in an M bar configuration. It should be understood that the M bar configuration includes two raised portions forming a channel therebetween. The M bar configuration enables cable 222 to be drawn in the channel facing ceiling 214 i.e., in between elongated bar 204 and ceiling 214. This ensures cable 222 is not seen from underneath fan 206.

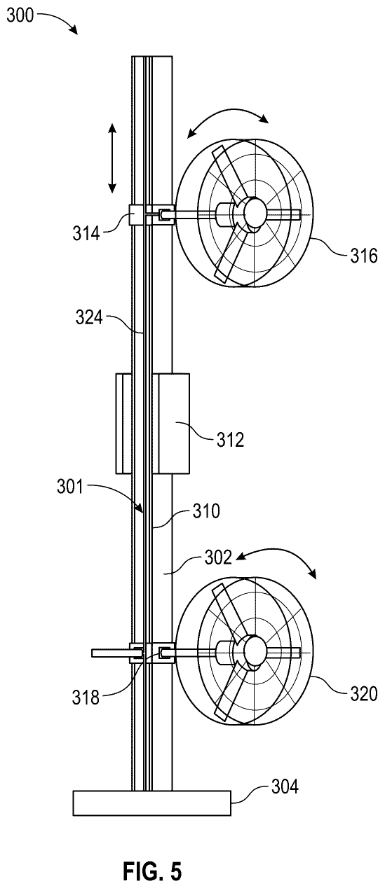

FIG. 5 shows an environment 300, in which an apparatus 301 implements, in accordance with one embodiment of the present invention. Apparatus 301 includes an elongated bar 302 made of metal, wood or any other suitable material. Here, elongated bar 302 indicates a freestanding pole or telescopic pole made of a metal, wood, hard plastic or any other material. In one example, elongated bar 302 has a support base 304 at the bottom. Support base 304 acts as a base structure that helps to position elongated bar 302 in an upright position. Support base 304 comes in a variety of shapes and sizes depending on the need.

In accordance with the present embodiment, elongated bar 302 includes rail members 310. Rail members 310 extend the entire or substantial length of elongated bar 302. In one example, rail members 310 connect to elongated bar 302 with the help of a bracket 312. Bracket 312 helps to removably connect rail members 310 to elongated bar 302. Further, rail members 310 includes a first connecting rod 314. First connecting rod 314 is configured to slide along the rail members 310 such that the position of the first connecting rod 314 is adjustable with respect to the height from support base 304.

Here, first connecting rod 314 receives a first fan 316. In one example, first connecting rod 314 pivots such that first fan 316 is made to turn/rotate at a desirable angle to circulate air in a room or building. Optionally, first fan 316 is connected to first connecting rod 314 in a fixed angle such that first fan 316 is made to circulate air at a fixed direction.

Furthermore, rail members 310 includes a second connecting rod 318. Second connecting rod 318 is configured to slide along the rail members 310 such that the position of second connecting rod 318 is adjustable with respect to the height from support base 304. Second connecting rod 318 receives a second fan 320. In one exemplary embodiment, second fan 320 is the same as first fan 316. In another exemplary embodiment, second fan 320 is different from first fan 316. In one example, second connecting rod 318 pivots such that the second fan 320 is made to turn/rotate at a desirable angle to circulate air in a room or building. Optionally, second fan 320 is connected to second connecting rod 318 in a fixed angle such that second fan 320 is made to circulate air at a fixed direction. In one example, rail members 310 include wiring 324 for operating fans 316, 320.

The present embodiment presents apparatus 301 that is easily moveable from one place to another. A user (not shown) shifts the location of the apparatus 301 to another to circulate air in a particular portion of the room. In one alternate embodiment, support base 304 includes wheels (not shown) such as caster wheel, for example. The wheels help to move apparatus 301 from one location to another.

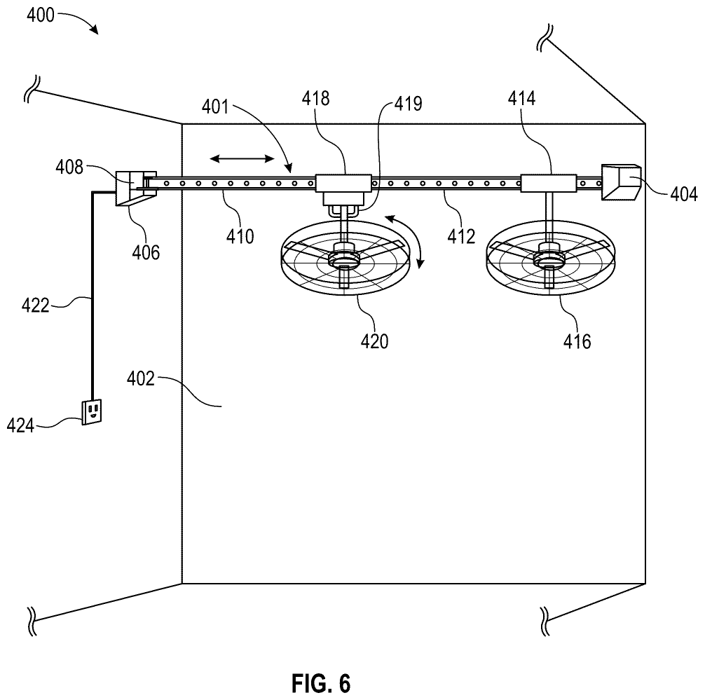

FIG. 6 shows an environment 400, in which an apparatus 401 implements, in accordance with one embodiment of the present invention. Apparatus 401 mounts at walls 402 from side to side, or front to rear, or even diagonally adjacent walls depending on the need. Apparatus 401 includes a first support bracket 404 and a second support bracket 406. First support bracket 404 mounts at one side of wall 402 and second support bracket 406 mounts at the opposite side of wall 402. In one example, each of first support bracket 404 and second support bracket 406 includes bar receiving sections 408. Bar receiving sections 408 indicate cut-sections in first support bracket 404 and second support bracket 406 for receiving a second telescopic pole 412, and a first telescopic pole 410, respectively. Bar receiving sections 408 position vertically with respect to walls 402. In the present embodiment, the length of first telescopic pole 410 and second telescopic pole 412 are adjustable. In one example, first telescopic pole 410 and second telescopic pole 412 are connected by a third bracket 418. Third bracket 418 acts as a bridge for connecting first telescopic pole 410 and second telescopic pole 412 at the middle while first telescopic pole 410 and second telescopic pole 412 are supported from second support bracket 406 and first support bracket 404 from walls 402 at their distal ends. Further, third bracket 418 includes a fan receiving section 419 positioned at the bottom. Fan receiving section 419 comes in a U-shaped configuration and receives second fan 420.

In one example, one of first telescopic pole 410 and second telescopic pole 412 includes a first connecting rod 414. First connecting rod 414 receives a first fan 416. In one example, first connecting rod (swivel rod) 414 pivots/swivels such that first fan 416 is made to turn/rotate/swivel at a desirable angle to circulate air in a room or building. Optionally, first fan 416 is connected to first connecting rod 414 in a fixed angle such that first fan 416 is made to circulate air at a fixed direction. In one preferred embodiment, first fan 416 is made to face downwards to circulate air inside a room.

In addition, apparatus 401 includes a second fan 420. Here, second fan 420 mounts at third bracket 418 via fan receiving section 419. In one example, second fan 420 pivotably connects to third bracket 418 to turn/rotate at a desirable angle to circulate air in a room or building. Optionally, second fan 420 is connected to third bracket 418 in a fixed angle such that second fan 420 is made to circulate air at a fixed direction. In one preferred embodiment, second fan 420 is made to face downwards to circulate air inside a building.

A person skilled in the art understands that the present embodiment is shown to present one fan (i.e., second fan 420) connected to third bracket 418 and another fan (i.e., first fan 416) connected to first connecting rod 514 at second telescopic pole 412. However, it is possible to provide an additional fan at first telescopic pole 410 making three fans in apparatus 401. Alternatively, only one fan (i.e., second fan 420) is provided at third bracket 418 (without first fan 416 at second telescopic pole 412) depending on the need.

In one example, each of first fan 416 and second fan 420 draws electrical energy from a power supply through a switchboard or a control board or an electrical outlet 524. Control board 524 positions on wall 402 as shown in FIG. 6. In one example, control board 524 includes a cable 522 extending from control board 524 and connecting apparatus 401. Cable 522 draws through first telescopic pole 410 and second telescopic pole 412 and supplies the electrical energy from control board 524 to fans 416, 420 to operate them.

In operation, each of first fan 416 and second fan 420 either alone or in combination is operated using wired cable 522 or via a remote control as known in the art. Here, each of first fan 416 and second fan 420 is operated to circulate the air in the room. After use, first telescopic pole 410 and second telescopic pole 412 are lifted, turned upside down to place them in bar receiving sections 408 of second support bracket 406 and first support bracket 404, respectively. This positions first fan 416 and second fan 420 facing the ceiling. When needed, first telescopic pole 410 and second telescopic pole 412 are lifted and placed in bar receiving sections 408 such that first fan 416 and second fan 420 face downwards as shown in FIG. 6.

A person skilled in the art understands that the elongated bar is positioned between two opposite surfaces such as walls, along the wall, or along the ceiling within the structure/building.

The presently disclosed apparatus provides several advantages over the prior art. The apparatus includes an elongated bar such as an M bar that is connected to walls of opposite sides for connecting one or more fans. Alternatively, the elongated bar is connected to the ceiling and the floor. The elongated bar helps to avoid connecting the fan directly to the ceiling or wall as in the prior art. In case the fan needs repair or replacement, the fan can be removed from the elongated bar and repaired or replaced with a new fan without damaging the ceiling or the wall. Further, if the structure is large, then multiple elongated bars can be used to connect between the walls to connect one or more fans to provide required air circulation in the structure. Furthermore, the position of the fans can be adjusted along the length of the elongated bar depending on the need.

A person skilled in the art appreciates that the apparatus can come in a variety of shapes and sizes depending on the need and comfort of the user. Further, many changes in the design and placement of components may take place without deviating from the scope of the presently disclosed apparatus.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. An apparatus for mounting a fan, said apparatus comprising:
a plurality of elongated bars, each elongated bar comprising an M-shaped cross-section, wherein said elongated bar of said plurality of elongated bars mounts at a surface of a structure; and
one or more connecting rods attached to said plurality of elongated bars, wherein said one or more connecting rods receive one or more fans; and
a cable drawn along said M-shaped cross-section of said elongated bar for supplying electrical energy to said one or more fans.

2. The apparatus of claim 1, wherein said surface comprises a wall in said structure.

3. The apparatus of claim 1, wherein said surface comprises a ceiling in said structure.

4. The apparatus of claim 1, wherein said plurality of elongated bars comprises telescopic bars.

5. The apparatus of claim 1, wherein said plurality of elongated bars is connected by one or more brackets.

6. The apparatus of claim 5, wherein said one or more brackets slidably connect to said plurality of elongated bars.

7. The apparatus of claim 1, wherein said M-shaped cross-section of said elongated bar comprises raised portions forming a channel therebetween, and wherein said channel faces said surface for concealing said cable between said elongated bar and said surface of said structure.

8. The apparatus of claim 1, wherein a connecting rod of said one or more connecting rods connects to said elongated bar of said plurality of elongated bars at an angle via a swivel rod.

9. An apparatus for mounting a fan, said apparatus comprising:
a plurality of elongated bars, each elongated bar comprising an M-shaped cross-section, wherein said elongated bar of said plurality of elongated bars mounts at a surface of a structure; and
one or more connecting rods attached to said plurality of elongated bars, wherein said one or more connecting rods receive one or more fans; and
a cable drawn along said M-shaped cross-section of said elongated bar for supplying electrical energy to said one or more fans,
said M-shaped cross-section of said elongated bar comprises raised portions forming a channel therebetween, and wherein said channel faces said surface for concealing said cable between said elongated bar and said surface of said structure.

10. The apparatus of claim 9, wherein said surface comprises a wall in said structure.

11. The apparatus of claim 9, wherein said surface comprises a ceiling in said structure.

12. The apparatus of claim 9, wherein said plurality of elongated bars comprises telescopic bars.

13. The apparatus of claim 9, wherein said plurality of elongated bars is connected by one or more brackets.

14. The apparatus of claim 13, wherein said one or more brackets slidably connect to said plurality of elongated bars.

15. The apparatus of claim 9, wherein said a connecting rod of said one or more connecting rods connects to said elongated bar of said plurality of elongated bars via a swivel rod for swiveling said one or more fans at an angle.

16. A method of providing an apparatus for mounting a fan, said method comprising the steps of:
providing a plurality of elongated bars, each elongated bar comprising an M-shaped cross-section, said elongated bar of said plurality of elongated bars mounting at a surface of a structure; and
providing one or more connecting rods attached to said plurality of elongated bars, said one or more connecting rods receiving one or more fans; and
drawing a cable along said M-shaped cross-section of of said elongated bar for supplying electrical energy to said one or more fans.

17. The method of claim 16, further comprising providing raised portions forming a channel therebetween at said M-shaped cross-section, said channel facing said surface for concealing said cable between said elongated bar and said surface of said structure.

18. The method of claim 16, further comprising connecting said plurality of elongated bars by one or more brackets.

19. The method of claim 16, further comprising slidably connecting said plurality of elongated bars using said one or more brackets.

20. The method of claim 16, further comprising connecting a connecting rod of said one or more connecting rods to said elongated bar of said plurality of elongated bars at an angle via a swivel rod.
